(19) United States
(12) Patent Application Publication
(10) Pub. No.: US 2014/0003237 A1
(43) Pub. Date: Jan. 2, 2014

(54) SYSTEMS AND METHODS FOR OPERATING WIRELESS DEVICES IN DYNAMIC FREQUENCY SELECTION (DFS) BANDS

(71) Applicants: Thomas J. Kenney, Portland, OR (US); Eldad Perahia, Portland, OR (US)

(72) Inventors: Thomas J. Kenney, Portland, OR (US); Eldad Perahia, Portland, OR (US)

(21) Appl. No.: 13/537,390

(22) Filed: Jun. 29, 2012

(51) Int. Cl. H04W 28/10

(52) U.S. Cl. CPC H04W 28/10
USPC 370/235

(57) ABSTRACT

Described herein are tools and techniques related to communications in a dynamic frequency selection (DFS) band. A wireless device may include a DFS selector module that is configurable to establish a Peer-to-Peer (P2P)/Wi-Fi Direct service, and based on the content provided in that service, establish the service within the DFS band. In one implementation, the DFS selector module may establish communication with an access point (AP); receive a request from a client device via the AP to deliver content using a P2P link; deliver the content to the client device via the AP using the P2P link; determine whether the P2P link is congested; scan for an open channel in the DFS band in response to determining that the P2P link is congested; and send a request to the client device via the AP to establish a direct connection using the open channel from the DFS band.

### BACKGROUND

In the field of wireless communications, Wireless Fidelity (Wi-Fi) technology based on the IEEE 802.11 and/or 802.16 family of standards is being incorporated into virtually all electronic devices including laptops, notebooks, smart phones, gaming and entertainment devices including high definition (HD) televisions, and similar other. Conventional Wi-Fi networks are typically based on the presence of one or more controller devices known as a Wi-Fi access point (AP) or hotspot. More recently, Wi-Fi Certified Direct (supported by the Wi-Fi Alliance) devices have been introduced that may connect to each other using peer-to-peer (P2P) communications without having to go through the AP.

The need for higher wireless speeds, and higher bandwidths are increasingly favoring the use of 5 Giga Hertz (GHz) band compared to the more congested 2.4 GHz band. However, Federal Communications Commission (FCC), along with other foreign regulatory bodies such as European Telecommunications Standards Institute (ETSI), have promulgated strict requirements to operate in the (Dynamic Frequency Selection) DFS portion of the 5 GHz band. DFS is a mechanism to allow unlicensed wireless devices to share spectrum with existing radar systems (for e.g., weather radars at or near airports). Per regulatory requirement, a Wi-Fi device (e.g., AP or a controller) must scan channels sufficiently to guarantee a certain confidence level of any radar activity. If the monitoring of the DFS band detects a radar, the controller device must leave the channel within a designated time. The need to scan for radar signals in the DFS band necessitates long scan intervals, and often results in poor performance

### BRIEF DESCRIPTION OF THE DRAWINGS

FIG. 1A illustrates a block diagram of a communication system.

FIG. 1B illustrates frequency and channel allocations in the 5 GHz band for Wi-Fi networks.

FIG. 2 is a block diagram of a wireless device that may be used to implement devices described with reference to FIG. 1A.

FIG. 3 is a time sequence diagram illustrating transactions performed by a P2P group owner to establish a Wi-Fi direct link on a DFS channel with a P2P client device.

FIG. 4 shows an example process chart illustrating an example method for communications using a channel located in a dynamic frequency selection (DFS) band.

The following Detailed Description is provided with reference to the accompanying figures. In the figures, the left-most digit(s) of a reference number usually identifies the figure in which the reference number first appears. The use of the same reference numbers in different figures indicates similar or identical items.

### DETAILED DESCRIPTION

This document discloses one or more systems, apparatuses, methods, etc. for communications using channels located in a dynamic frequency selection (DFS) band. Although described in the context of wireless communication networks, it is understood that, unless otherwise stated, any communication network or device described herein may be implemented as a wired or wireless network or device. In an implementation, a wireless device may include a DFS selector module that is configurable to establish a Peer-to-Peer (P2P)/Wi-Fi Direct service, and based on the content provided in that service, establish the service within the DFS band. The DFS selector module may establish communication with an access point (AP); receive a request from a client device via the AP to deliver content using a P2P link; deliver the content to the client device via the AP using the P2P link; determine whether the P2P link is congested; scan for an open channel in the DFS band in response to determining that the P2P link is congested; and send a request to the client device via the AP to establish a direct connection using the open channel from the DFS band.

In a Wi-Fi network, a client device that would like to setup a P2P/Wi-Fi Direct link with other Wi-Fi Direct devices and perform group management functions for the group may be referred to as a P2P group owner. A device that may be configured to be associated with or connected to this group owner using the Wi-Fi direct connection may be referred to as the P2P client device. In an implementation, the P2P group owner may be configured to be associated with any AP in the 5 GHz band using existing discovery and accessing techniques such as a direct link setup (DLS) technique and a tunneled direct link setup (TDLS) technique.

In one implementation, a Wi-Fi Direct/P2P link may be setup through the associated AP using an available channel in the 5 GHz band. The Wi-Fi Direct/P2P link may be established via the AP using the DLS or the TDLS technique. If the P2P group owner determines, or if the AP suggests that the current channel is congested, then additional action may be taken by the group owner (and potentially by the AP) to improve the quality of service (QOS). The technique to establish communications in the DFS band allows for improving the QOS by enabling a P2P/Wi-Fi Direct link that is established in the DFS band between the P2P group owner and the P2P client device.

Per regulatory requirements, any device that operates in the DFS band is required to scan the DFS band itself to exclude channels used by radar systems in the 5 GHz spectrum. The current guidelines typically do not allow the P2P group owner device to accept or rely upon the scan results from another device. Thus, to assure compliance with regulatory requirements, scanning of the DFS band to detect presence of radar signals is performed by the P2P group owner.

Once the initial Wi-Fi Direct link is established and the content such as streaming video service is rendered (allowing the user to view the streaming video), the P2P group owner and AP may exchange information about the performance and responsiveness of the current P2P link and the channel used. If the link is congested, the P2P group owner may continue to deliver the content to the P2P client device via the AP, although the QOS may be suboptimal. In order to improve the QOS, the P2P group owner may use the time where the P2P group owner is not using the medium (e.g., other devices coupled to the AP may be busy communicating with the AP), to scan for an available or open channel in the DFS band that is free from radar interference. When the open DFS channel is found, the P2P group owner may transmit and establish a connection with the P2P client device. The services provided by the P2P link may now be provided on the DFS channel, thereby bypassing the AP.

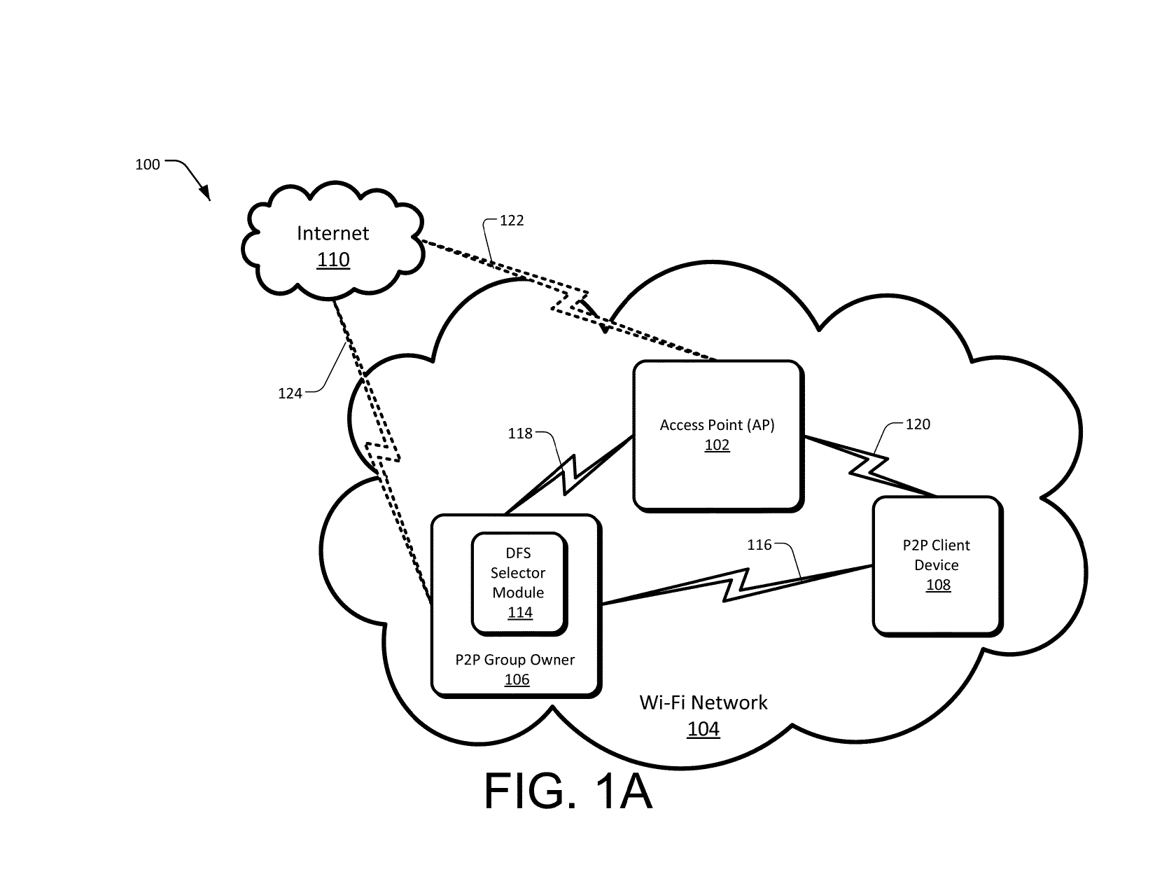

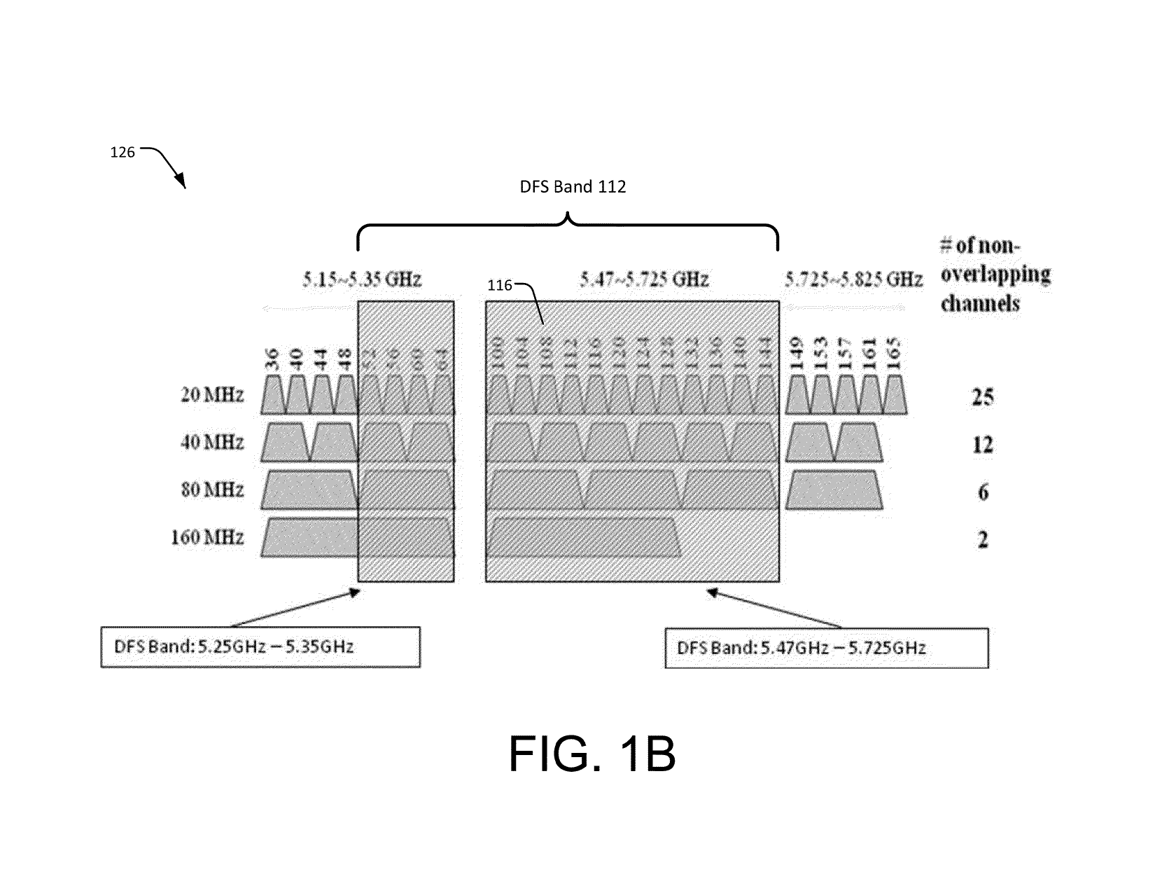

FIG. 1A illustrates a block diagram of a communication system 100 configured to provide Wi-Fi direct service in 5 GHz band using a DFS channel. In one implementation, the communication system 100 may include an access point (AP) 102 configured to control the flow of data in a Wi-Fi network 104. Network devices that are controlled by the AP 102 may include a P2P group owner 106 and a P2P client device 108. It is understood that additional network devices (not shown) may be coupled to the AP 102. The AP 102 and the P2P group owner 106 may be configured to independently access the Internet 110 via communication links 122 and 124 respectively.

In an implementation, the P2P group owner 106 and a P2P client device 108 may be Wi-Fi Certified Direct devices that support peer-to-peer (P2P) communications via the AP 102 or configured to communicate directly and independently of the AP 102. P2P links enable peer-to-peer communications in which users may use the Wi-Fi network 104 and/or the Internet 110 to exchange files with each other directly or through a mediating server such as the AP 102. In one application, the AP 102 may also be a Wi-Fi Certified Direct device.

The Wi-Fi Certified Wi-Fi Direct (may also be referred to as Wi-Fi Direct-Certified (WFDC) or Wi-Fi Direct) is a certification program set up by the Wi-Fi Alliance that enables Wi-Fi devices to communicate with each other. Wi-Fi devices may be able to make direct connection groups quickly and conveniently for users to perform functions like print, sync, and share content—even when an AP or router is unavailable. Connections based on the specification published by the Wi-Fi Alliance operate at typical Wi-Fi speeds and range, are protected by established security protocols, and include Quality of Service (QOS) mechanisms.

In an implementation, the P2P group owner 106 may use the DLS or TDLS technique to establish a wireless connection 118 with the AP 102. The P2P client device 108 may establish a similar wireless connection 120 with the AP 102 to communicate with the P2P group owner 106. Other techniques for discovering available Wi-Fi networks and establishing P2P connections may include Bonjour and UPnP protocols. The AP 102 may be configured to operate in the 2.4 GHz band, the 5 GHz band, or both. Typical transactions that may be processed by the Wi-Fi Certified Direct devices (with or without the AP 102) may include providing a requested service or delivering requested content such as delivering a print job to a wireless printer, transferring photos from a camera to a laptop, receiving streaming video content via the Internet 110 with a smart phone and delivering it to a HD TV client device, and others in a wireless manner.

FIG. 1B illustrates a graphical representation 126 of frequency and channel allocations in the 5 GHz band for Wi-Fi network communication. Bandwidths supported in the 5 GHz band include 20 MHz (having 25 non-overlapping channels), 40 MHz (having 12 non-overlapping channels), 80 MHz (having 6 non-overlapping channels), and 160 MHz (having 2 non-overlapping channels). Due to the possibility of interference from radar sources, typically only the bottom four channels (36, 40, 44 and 48) and top five channels (149, 153, 157, 161 and 165) are used by most Wi-Fi devices. The DFS band 112, which excludes the bottom four channels and top five channels, includes a first DFS band with frequencies from 5.25 to 5.35 GHz and a second DFS band with frequencies from 5.47 to 5.72 GHz.

Referring to FIGS. 1A and 1B, the P2P group owner 106 may be configured to include a DFS selector module 114 that is operable to select one or more channels in the DFS band 112 to improve quality of service (QOS). The QOS may be established by measuring parameters such as time delay, available bandwidth, throughput rate, noise/crosstalk, and others. The QOS may be deemed to be less than acceptable if the measurement criteria deviates from a benchmark by more than a predefined threshold value, e.g., when bit rate for data transfer drops below 600 kilobits per second in one application.

The wireless connection 118 between P2P group owner 106 and the AP 102 may utilize any available channel that lies outside of the DFS band 112. Similarly, the wireless connection 120 between P2P client device 108 and the AP 102 may share the same channel as 118 or any available channel that lies outside of the DFS band 112. The P2P client device 108, which may be a HD TV with built-in Wi-Fi access, may request a P2P communication service such as delivery of streaming video (referred to as content) for display. To service the request a P2P direct link may be setup between the P2P group owner 106 and the P2P client device 108 via the AP 102. The initial Wi-Fi direct P2P link may utilize any available channel that lies outside of the DFS band 112. Password entry or similar other security features may be configured to set up a secure P2P link.

In one implementation, the P2P group owner 106 may acquire the requested content, e.g., streaming video for HD TV, from the Internet 110 and provide the requested content to the P2P client device 108 via the AP 102. As described earlier, the channel used for the delivery of the requested P2P content lies outside of the DFS band 112. In response to evaluating one or more QOS benchmarks, the P2P group owner 106 and/or the AP 102 may determine that the P2P link is congested, e.g., throughput rate is below a threshold value.

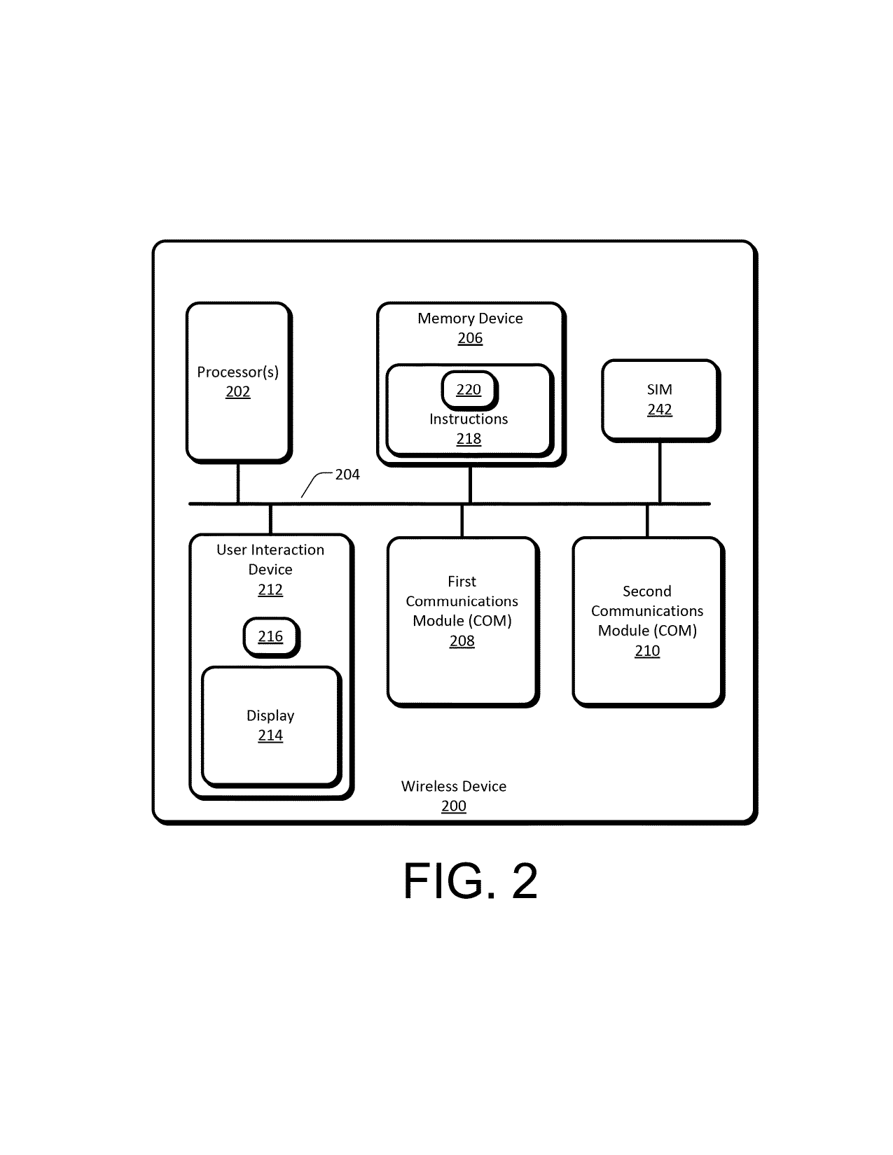

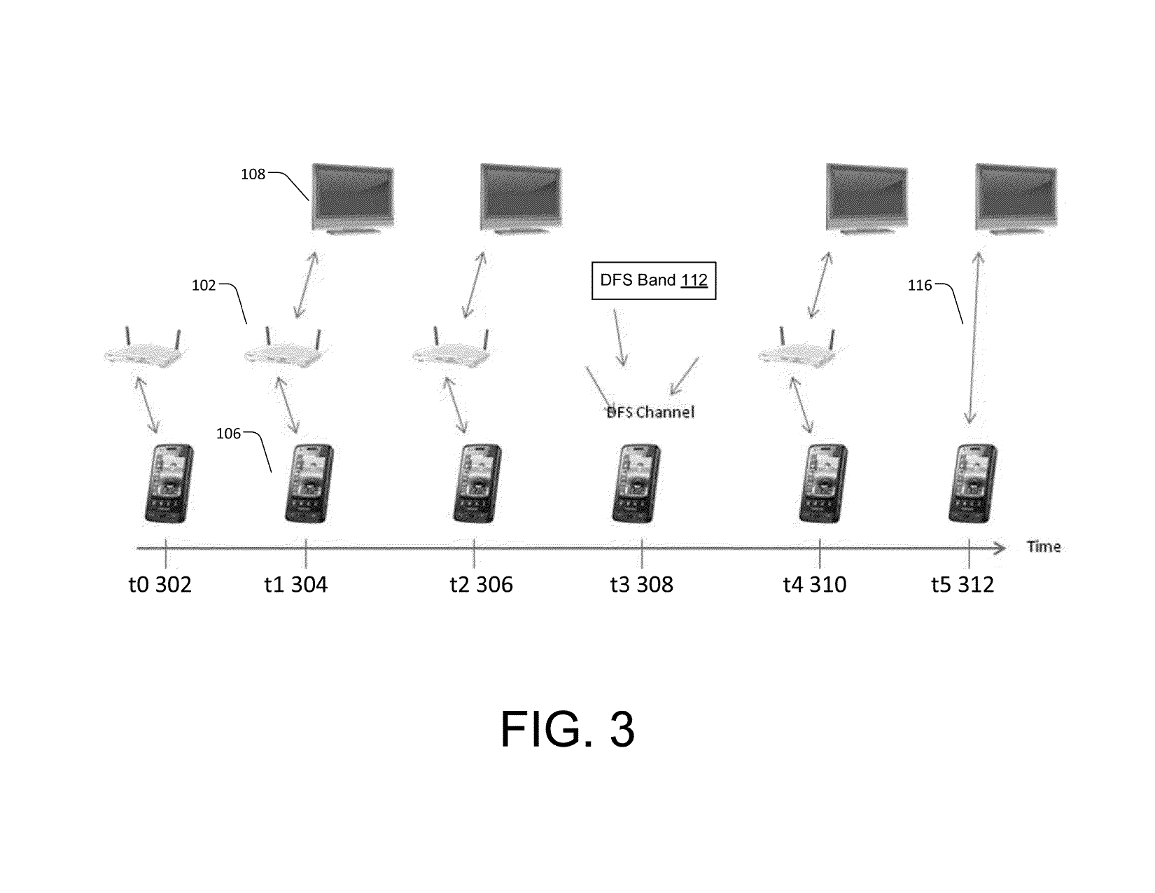

The DFS selector module 114 may be configured to improve the QOS performance by selecting an open (or available DFS channel) 116 in the DFS band 112 that is free from radar interference and delivering the requested content to the P2P client device 108 via the open channel 116 in the DFS band 112, bypassing the AP 102. Although, channel 108 is shown as the open channel 116, it is understood that any one of the channels in the DFS band 112 may be tested to be open. The operation of the DFS selector module 114 is transparent to the user and is automatically activated based on QOS measurement. Additional details of the functions performed by the DFS selector module 114 are described with reference to FIGS. 2 and 3.

Although not expressly shown in FIG. 1A, the P2P group owner 106 and the P2P client device 108 are both computing devices (or computer systems) that may include hardware, firmware, and/or software, which are configured to perform, at least in part, the techniques described herein. The computing devices may also include infrastructure software, application software, middleware, databases, knowledge bases, and similar other components. In addition, it is understood that the communication system 100 may include additional number of wireless devices and/or hardwired devices to fit the transaction processing requirements.

It is contemplated that the communication system 100 may be adapted to scan and select any available, interference-free channels in any radio frequency (RF) band (and not just DFS band) that may be shared between multiple RF devices to improve performance and QOS.

FIG. 2 is a block diagram of a wireless device 200 that may be used to implement the P2P group owner 106 and the P2P client device 108 described with reference to FIG. 1A. In one implementation, the wireless device 200 is a Wi-Fi Certified Direct device. Examples of such wireless devices include, but are not limited to, Ultrabooks, a tablet computer, a netbook, a notebook computer, a laptop computer, mobile phone, a cellular phone, a smartphone, a personal digital assistant, a multimedia playback device, a digital music player, a digital video player, a navigational device, a digital camera, and the like.

In an implementation, the wireless device 200, which is a type of a computer system, includes a processor 202 coupled to a bus 204, a memory device 206 coupled to the processor 202 via the bus 204, a first communications module (COM) 208 coupled to the processor 202 via the bus 204, a second COM 210 coupled to the processor 202 via the bus 204, and a user interaction device 212 coupled to the processor 202 via the bus 204.

The user interaction device 212 may include a display 214 and an input device 216 such as a touch screen, a mouse, a trackball, or similar other cursor positioning peripheral configured to receive user input. The display 214 is configured to provide a graphical user interface for user interaction. Although not shown, the input device 216 may include a smaller sized QWERTY type fixed keypad for user input. In some applications, the display 214 and the input device 216 may be configured as separate components that may be directly coupled to the bus 204.

It should be understood that depending on the computing load, more than one processor 202 may be included in the wireless device 200. The memory device 206 and media are operable to store instructions or commands 218 that are executable by the processor 202 to perform one or more functions. It should also be understood that the term “computer system” is intended to encompass any device having a processor that is capable of executing program instructions from a memory medium. Various functions, processes, method(s) 400, programs, and operations described herein may be implemented using the wireless device 200. For example, the processor 202 is operable to execute specific instructions 220 stored in memory device 206 or media for performing one or more functions of the DFS selector module 114.

The components of the wireless device 200 may be modules of computer-executable instructions, which are instructions executable on a computer, mobile device, or the processors of such devices. While shown here as modules, e.g., the DFS selector module 114, the components may be embodied as hardware, firmware, software, or any combination thereof The techniques described herein may be performed, as a whole or in part, by hardware, software, firmware, or some combination thereof

In some implementations, the wireless device 200 may provide support for communications over shorter distances. The first COM 110 may be configured to wirelessly communicate over short distances using a first communication standard such as NFC or Bluetooth. The NFC standard provides secure authenticated communications between two NFC compliant devices (not shown) located in close proximity.

The second COM 112 may be configured to wirelessly communicate with communication network(s) such as the Wi-Fi network 104 over a local or wide area using a second communication standard. The second communication standard may be based on IEEE 802.11 family of standards for wireless local area network (WLAN), including Wi-Fi networks. The wireless device 200 may also be configured to support IEEE 802.16 family of standards for wireless broadband devices such as 2G, 3G or 4G cell phones with LTE or WiMAX capability. The second COM 210 may be configured to support wireless connections such as 118, 120, 122, and 124 described with reference to FIG. 1.

FIG. 3 is a time sequence diagram illustrating transactions performed by a P2P group owner to establish a Wi-Fi Direct link on a DFS channel with a P2P client device. At time t0 302, the P2P group owner 106 associates with the AP 102. At time t1 304, the P2P group owner 106 sets up a Wi-Fi direct link with the Wi-Fi direct enabled client device such as the P2P client device 108 via the AP 102. In one implementation, the P2P client device 108 is a wireless HD TV device. At t2 306, the P2P group owner 106 may exchange information with the AP 102 to aid it's scanning of the DFS band 112 for the open channel 116 (free from radar signal interference) while providing the Wi-Fi direct connection to the P2P client device 108 via the AP 102.

At t3 308, the P2P group owner 106 initiates scanning of the DFS band 112 to locate a radar-free channel. The scanning may be performed by the P2P group owner 106 when the current channel that is used to communicate with the AP 102 is busy, e.g., is being used by other Wi-Fi devices communicating on the Wi-Fi network 104 controlled by the AP 102.

The process of scanning for an available channel in the DFS band 112 may be aided by the AP 102 in several ways. For example, the AP 102 may provide the P2P group owner 106 device with a list of channels within the DFS band 112 which it has scanned in the past and found to be unoccupied by any radars. This information may reduce the search space within the DFS band 112 that the P2P group owner 106 device may scan initially, e.g., by helping to prioritize the scanning range of frequencies. This may reduce the scanning time and power consumption of the device. However, the P2P group owner 106 may not completely rely on the information provided by the AP 102 and needs to verify that the AP 102 identified DFS channel is still available and free from radar use.

As a second example, the AP 102 may aid the P2P group owner 106 in establishing a connection in the DFS band 112 by controlling traffic on its own network during the scanning This may be performed by promoting aggregation for the other devices so that the P2P group owner 106 is allotted more time to scan at any one instance. It could also be aware that the P2P group owner 106 will be “off air” for a fixed duration. AP 102 may use ‘Request To Send’ and ‘Clear To Send’ (RTS/CTS) commands to hold the medium just prior to the devices return so that the P2P group owner 106 device may gain quick access of the medium and continue to provide the content service through the AP 102.

At t4 310, in response to the P2P group owner 106 detecting and verifying existence of the open channel 116 in the DFS band 112 (also referred to as the open DFS channel 116), the P2P group owner 106 may inform the AP 102 and the P2P client device 108 of the selection of the open DFS channel 116 for the P2P link. At t5 312, the P2P group owner 106 may broadcast on the open DFS channel 116 and the P2P client device 108 associates the Wi-Fi direct link with the open DFS channel 116. The P2P group owner 106 may start delivering the content directly to the P2P client device 108 using the open DFS channel 116 and bypassing the AP 102.

A benefit of establishing a Wi-Fi direct link in this manner is that the P2P group owner 106 may communicate the DFS channel to the P2P Client device 108 on the current link (e.g., non-DFS channel, using DLS or TDLS connection). Thus, establishing or using a socialization channel may not be required. A socialization channel, although not specified for the 5 GHz band, may be defined as a channel used by Wi-Fi direct devices to check if there are other devices available to form a group.

In one implementation, the P2P group owner 106 may contend for the medium as normal, and when it receives a packet that is intended for another device, it may use the network access vector (NAV) feature used by other devices packet to set an action time to perform scanning of the DFS band 112. Once a channel has been scanned for sufficiently long time duration to attain an acceptable confidence interval it may execute the steps to establish a Wi-Fi direct connection on that DFS channel. The Wi-Fi direct connection between the P2P group owner 106 and the P2P client device 108 leverage the superior bandwidth and other performance enhancing features of the DFS channel without having to route the content information via the AP 102.

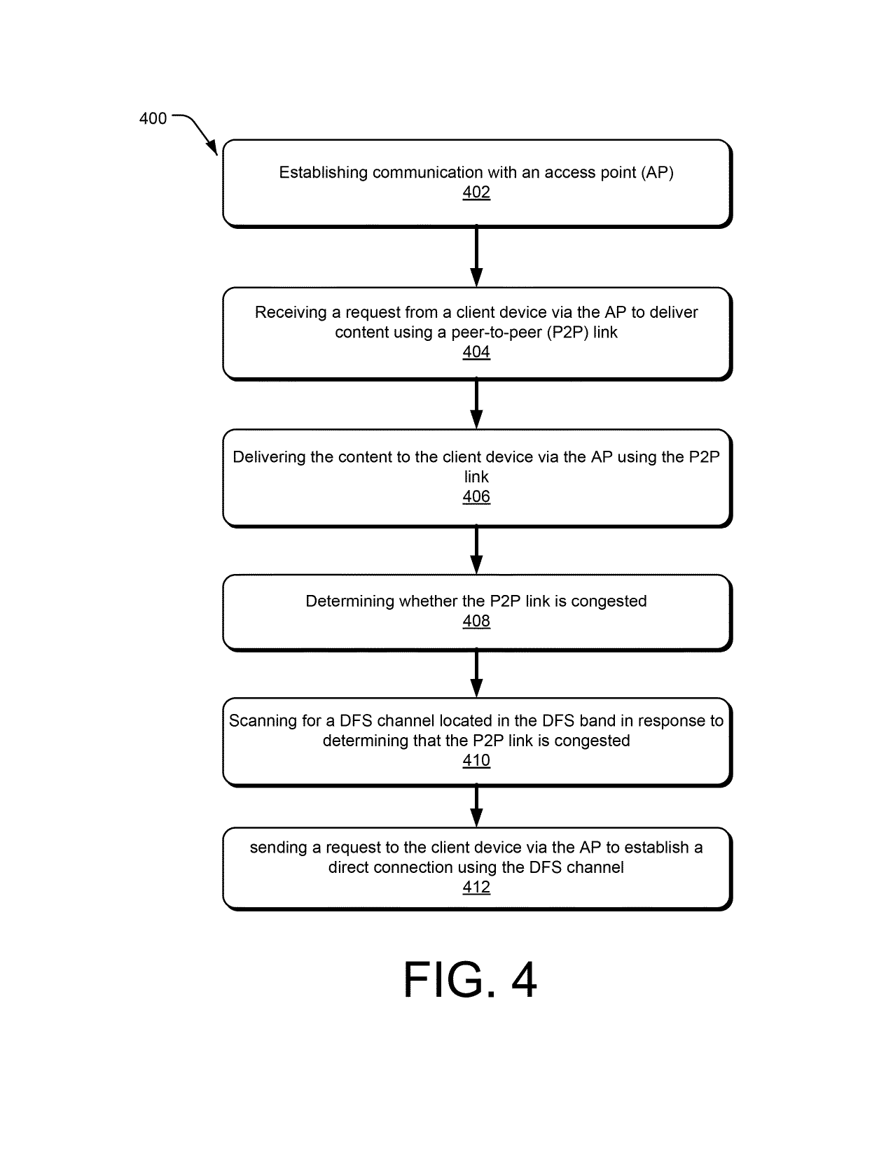

FIG. 4 shows an example process chart illustrating an example method 400 for communications using channels located in a dynamic frequency selection (DFS) band. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 402, establishing communication with an access point (AP) is performed. In an implementation, the communication link may be established by using at least one of direct link setup (DLS) technique and tunneled direct link setup (TDLS) technique. At block 404, receiving a request from a client device via the AP to deliver content using a peer-to-peer (P2P) link is performed. At block 406, delivering the content to the client device via the AP using the P2P link is performed. At block 408, determining whether the P2P link is congested is performed. At block 410, scanning for a DFS channel located in the DFS band is performed in response to determining that the P2P link is congested. At block 412, sending a request to the client device via the AP to establish a direct connection using the DFS channel is performed.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A mobile device for communicating in a dynamic frequency selection (DFS) band, the mobile device comprising:
one or more processors;
a memory coupled to the one or more processors; and
a DFS selector module configured to:
establish communication with an access point (AP);
receive a request from a client device via the AP to deliver content using a peer-to-peer (P2P) link;
deliver the content to the client device using the P2P link;
determine whether the P2P link is congested;
scan for an open channel in the DFS band in response to determining that the P2P link is congested; and
send a request to the client device via the AP to establish a direct connection using the open channel from the DFS band.

2. The mobile device as recited in claim 1, wherein the DFS selector module is configured to establish the communication with the AP using a channel that is located outside of the DFS band.

3. The mobile device as recited in claim 1, wherein the DFS selector module is configured to communicate with the client device that is a Wi-Fi Direct-Certified (WFDC) client.

4. The mobile device as recited in claim 1, wherein the DFS scanner module is further configured to:
receive information from the AP to aid in the scanning;
continue to deliver the content to the client device via the AP using the P2P link, the P2P link operating in the congested mode;
use the information from the AP to perform the scanning for the open channel during a time slot when a communications medium used for the P2P link is busy;
detect presence of a radar signal in the DFS band;
establish that the open channel is available in absence of the radar signal.

5. The mobile device as recited in claim 1, wherein the DFS selector module is further configured to bypass the AP to deliver the content directly to the client device using the open channel.

6. A method implemented by a wireless mobile device to communicate in a dynamic frequency selection (DFS) band, the method comprising:
establishing communication with an access point (AP);
receiving a request from a client device via the AP to deliver content using a peer-to-peer (P2P) link;
delivering the content to the client device via the AP using the P2P link;
determining whether the P2P link is congested;
scanning for a DFS channel located in the DFS band in response to determining that the P2P link is congested; and
sending a request to the client device via the AP to establish a direct connection using the DFS channel.

7. The method as recited in claim 6, wherein the communication with the AP is established using at least one of direct link setup (DLS) technique and tunneled direct link setup (TDLS) technique.

8. The method as recited in claim 1, wherein the communication with the AP is established using a channel that is located outside of the DFS band.

9. The method as recited in claim 6, wherein the communication with the AP is configured to operate in a 5 GHz band.

10. The method as recited in claim 6, wherein the client device is a Wi-Fi Direct-Certified (WFDC) client.

11. The method as recited in claim 6, wherein determination of whether the P2P link is congested includes:
comparing a quality of service (QOS) measurement with a benchmark; and
declaring that the P2P is congested if the QOS measurement is below a threshold value.

12. The method as recited in claim 6, wherein the scanning for the open channel includes:
receiving information from the AP to aid in the scanning;
continuing to deliver the content to the client device via the AP using the P2P link, the P2P link operating in the congested mode;
using the information from the AP to perform the scanning for the open channel during a time slot when a communications medium used for the P2P link is busy;
detecting presence of a radar signal in the DFS band;
establishing that the open channel is available in absence of the radar signal.

13. The method as recited in claim 12, wherein the AP is operable to control traffic flowing through the communications medium to increase the time slot, the traffic being controlled by aggregating requests from other devices coupled to the communications medium.

14. The method as recited in claim 6, wherein the request is sent to the client device using the P2P link.

15. The method as recited in claim 6, further comprising:
bypassing the AP to deliver the content directly to the client device using the open channel.

16. One or more computer-readable storage media storing instructions that, when executed by one or more processors, cause the one or more processors to perform acts comprising:
establishing communication with an access point (AP);
receiving a request from a client device via the AP to deliver content using a peer-to-peer (P2P) link;
delivering the content to the client device via the AP using the P2P link;
determining whether the P2P link is congested;
scanning for an open channel in a dynamic frequency selection (DFS) band in response to determining that the P2P link is congested; and
sending a request to the client device via the AP to establish a direct connection using the open channel from the DFS band.

17. The one or more readable media of claim 16, wherein the client device is a Wi-Fi Direct-Certified (WFDC) client.

18. The one or more readable media of claim 16, wherein determination of whether the P2P link is congested includes:
comparing a quality of service (QOS) measurement with a benchmark; and
declaring that the P2P is congested if the QOS measurement is unacceptable.

19. The one or more readable media of claim 16, wherein the scanning for the open channel includes:
receiving information from the AP to aid in the scanning;
continuing to deliver the content to the client device via the AP using the P2P link, the P2P link operating in the congested mode;
using the information from the AP to perform the scanning for the open channel during a time slot when a communications medium used for the P2P link is busy;
detecting presence of a radar signal in the DFS band;
establishing that the open channel is available in absence of the radar signal.

20. The one or more readable media of claim 16, wherein the AP is operable to control traffic flowing through the communications medium to increase the time slot, the traffic being controlled by aggregating requests from other devices coupled to the communications medium.
